(19) United States
(12) Patent Application Publication
(10) Pub. No.: US 2015/0271400 A1
(43) Pub. Date: Sep. 24, 2015

(54) HANDHELD ELECTRONIC DEVICE, PANORAMIC IMAGE FORMING METHOD AND NON-TRANSITORY MACHINE READABLE MEDIUM THEREOF

(71) Applicant: HTC Corporation, Taoyuan City (TW)

(72) Inventors: Yu-Mei CHEN, Taoyuan City (TW); Tung-Peng WU, Taoyuan City (TW); Lun-Cheng CHU, Taoyuan City (TW); Wei-Chung YANG, Taoyuan City (TW)

(73) Assignee: HTC Corporation, Taoyuan City (TW)

(21) Appl. No.: 14/219,377

(22) Filed: Mar. 19, 2014

(51) Int. Cl. H04N 5/232

(52) U.S. Cl. CPC H04N 5/23238

(57) ABSTRACT

A handheld device, a panoramic image forming method and a non-transitory machine readable medium thereof are provided. The present invention discloses a handheld electronic device for generating a panoramic image formed by a plurality of sub images, the handheld electronic device comprise an input unit, a display unit, an image sensor and a processor. The input unit senses a control action to generate a panorama signal. The image sensor captures a specific sub image of the plurality of sub images according to the panorama signal. The processor determines that the specific sub image is fuzzy so that the processor executes an image re-capturing program to: enable the display unit to display an image re-capturing interface; enable the image sensor to capture a first auxiliary image corresponding to the specific sub image; and replace the specific sub image by the first auxiliary image.

### CROSS-REFERENCES TO RELATED APPLICATIONS

Not applicable.

### BACKGROUND OF THE INVENTION

1. Field of the Invention

The present invention provides a handheld electronic device, a panoramic image forming method and a non-transitory machine readable medium thereof. In particular, the present invention provides a handheld electronic device, a panoramic image forming method and a non-transitory machine readable medium thereof for forming a panoramic image without fuzziness.

2. Descriptions of the Related Art

The panorama mode is commonly use in handheld electronic devices. When using the panoramic mode, a plurality of sub images are captured and stitched together to form a panoramic image.

However, the panoramic image may be unclear if any one of the sub images is fuzzy. For example, a panoramic image may be fuzzy if an object in the panoramic image is in motion while the panoramic image is being captured. In such case, a new panoramic image should be re-captured again.

As result, it is important to provide a method to form a clear panoramic image without re-capturing a new plurality of sub images.

### SUMMARY OF THE INVENTION

An objective of the present invention is to provide a handheld electronic device, a panoramic image forming method and a non-transitory machine readable medium thereof. The present invention provides a panoramic image forming method which can obtain a clear panoramic image without re-capturing a new panoramic image if one or more sub image(s) is/are fuzzy. Thereby, the panoramic image forming method of the present invention can increase users' convenience.

To this end, the present invention discloses a handheld electronic device for generating a panoramic image formed by a plurality of sub images. The handheld electronic device comprises an input unit, a display unit, an image sensor and a processor.

The input unit senses a control action to generate a panorama signal. The image sensor captures a specific sub image of the plurality of sub images according to the panorama signal. The processor that is electrically connected with the input unit, the display unit and the image sensor determines that the specific sub image is fuzzy so that the processor executes an image re-capturing program to enable the display unit to display an image re-capturing interface, to enable the image sensor to capture a first auxiliary image corresponding to the specific sub image, and to replace the specific sub image by the first auxiliary image.

Another objective of this invention is to provide a panoramic image forming method for use in a handheld electronic device. A panoramic image forming method for use in a handheld electronic device is described. The handheld electronic device comprises an input unit, a display unit, an image sensor and a processor electrically connected to the input unit, the display unit and the image sensor.

The input unit senses a control action to generate a panorama signal. The image sensor captures a plurality of sub images for forming a panoramic image according to the panorama signal. The panoramic image forming method comprises the following steps: determining that a specific sub image of the plurality of sub images is fuzzy to execute an image re-capturing program by the processor; displaying an image re-capturing interface corresponding to the image re-capturing program by the display unit; capturing a first auxiliary image corresponding to the specific sub image by the image sensor; and replacing the specific sub image by the first auxiliary image by the processor.

Yet a further objective of this invention is to provide a non-transitory machine-readable medium storing a program for a handheld electronic device to perform a panoramic image forming method. The handheld electronic device comprises an input unit, a display unit, an image sensor and a processor.

The input unit senses a control action to generate a panorama signal. The image sensor captures a plurality of sub images for forming a panoramic image according to the panorama signal. The program comprises the following: a code for the processor to determine that a specific sub image is fuzzy to execute an image re-capturing program; a code for the display unit to display an image re-capturing interface corresponding to the image re-capturing program; a code for the image sensor to capture a first auxiliary image corresponding to the specific sub image; and a code for the processor to replace the specific sub image by the first auxiliary image.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A depicts a functional block diagram of a handheld electronic device according to a first embodiment of the present invention;

FIG. 1B depicts a panorama interface displayed on a display unit according to the first embodiment of the present invention;

FIG. 1C depicts an image re-capturing interface displayed on the display unit according to the first embodiment of the present invention; and

FIG. 2 depicts a flowchart diagram of a panoramic image forming method according to a second embodiment of the present invention.

### DESCRIPTION OF THE PREFERRED EMBODIMENT

In the following description, the present invention will be explained with reference to embodiments thereof. However, the descriptions of these embodiments are only for purposes of illustration rather than limitations. It should be appreciated that in the following embodiments and the attached drawings, the elements not related directly to this invention are omitted from depiction and dimensional relationships among individual elements in the attached drawings are illustrated only for ease of understanding, and not limitation.

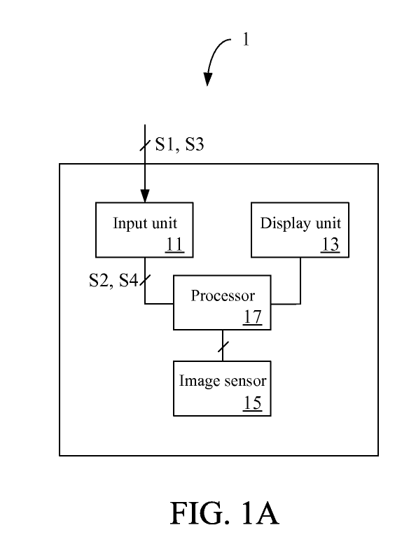

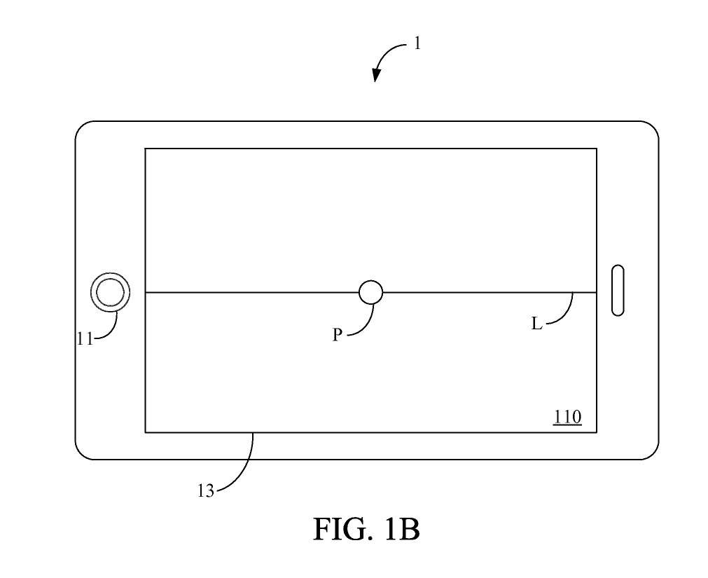

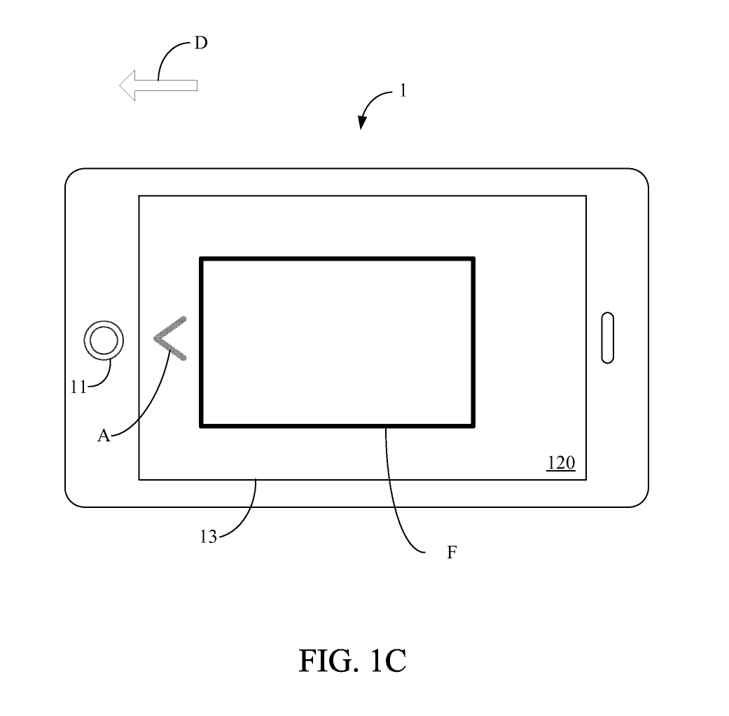

A handheld electronic device 1 according to a first embodiment of the present invention is shown in FIGS. 1A to 1C. FIG. 1A depicts a functional block diagram of the handheld electronic device 1, FIG. 1B depicts a panorama interface 110 displayed on the display unit 13, and FIG. 1C depicts an image re-capturing interface 120 displayed on the display unit 13.

The handheld electronic device 1 for generating a panoramic image comprises an input unit 11, a display unit 13, an image sensor 15 and a processor 17. The processor 17 is electrically connected to the input unit 11, the display unit 13 and the image sensor 15. As shown in FIGS. 1B and 1C, the input unit 11 can be, for example, a physical button, while the display unit 13 can be, for example, a monitor to display graphic user interface output. In another example, the input unit 11 and the display unit 13 can be integrated into a touch display panel. The image sensor 15 can be a camera, while the processor 17 can be, for example, a microprocessor, graphics processing unit (GPU) or application-specific integrated circuit (ASIC). Interactions among the components in the first embodiment will be further described hereinbelow.

The input unit 11 senses a first control action S1 from a user to generate a panorama signal S2. Then, the processor 17 executes a panorama program according to the panorama signal S2 to enable the display unit 13 to display a panorama interface 110 and to enable the image sensor 15 to capture a plurality of sub images to form the panoramic image.

As shown in FIG. 1B, the panorama interface 110 shows a central point P and a horizontal reference line L. When the panorama program is executed, the user may use the central point P and the horizontal reference line L to help the image sensor 15 to capture the plurality of sub images. It shall be particularly appreciated that the presentation on the panorama interface 110 of the present invention is not limited thereto.

Moreover, the processor 17 determines whether each of the plurality of sub images is fuzzy just after the corresponding sub image is captured by the image sensor 15.

Normally, a clear panoramic image will be obtained if each of the plurality of sub images is clear. Nevertheless, if any one of the plurality of sub images is fuzzy, the panoramic image may fuzzy too.

For example, it is assumed that the panoramic image is formed by stitching four sub images which are a first sub image, a second sub image, a third sub image and a fourth sub image. The processor 17 determines whether the first, second, third or fourth sub images are fuzzy just after the first sub image, second sub image, third sub image or fourth sub image is captured by the image sensor 15, respectively.

For example, if the processor 17 determines that the second sub image is fuzzy after the second sub image is captured, the following image re-capturing program will be executed to enable the display unit 13 to display an image re-capturing interface 120. The image sensor 15 is enabled to capture a first auxiliary image corresponding to the second sub image. The second sub image is replaced by the auxiliary image.

Specifically, the processor 17 may determines that the second sub image is fuzzy according to hardware information of the handheld electronic device 1 or a fuzzy detecting method. The fuzzy detecting method will be described below.

In more details, the hardware information can be a shutter period (corresponding to the second sub image) formed by the image sensor 15 when capturing the second sub image, or a motion sensor value formed by a motion sensor of the handheld electronic device 1. The motion sensor value is gained by measuring the motion sensor when the image sensor 15 is capturing the second sub image. The motion sensor value can be, but not limited to, at least one of the following: a sensor shift value while the motion sensor is a gravity sensor of the handheld electronic device 1, a gyroscope sensor shift value while the motion sensor is a gyroscope sensor of the handheld electronic device 1, or other sensor values which can represent the fleeting motion of the handheld electronic device 1.

More specifically, the processor 17 determines that the second sub image is fuzzy if the shutter period is determined to be lower than a shutter threshold value, if the sensor shift value of the gravity sensor is determined to be higher than a sensor shift threshold value, or if the gyroscope sensor shift value of the gyroscope sensor is determined to be higher than a gyroscope sensor shift threshold value. Wherein, the shutter threshold value can be adjusted by the processor 17 according to the environmental background. For example, the darker the environment background, the higher the shutter threshold value. Alternatively, the shutter threshold can be predetermined and pre-stored in a storage of the handheld electronic device 1.

As mentioned before, the second sub image can be determined to be fuzzy according to the fuzzy detecting method. The fuzzy detecting method, such as, an edge detecting method, a color distribution detecting method or a high-pass filter detecting method. Specifically, the high-pass filter detecting method can be a scale-invariant feature transform (SIFT) method, a speeded up robust features (SURF) method, an oriented-BRIEF (ORB) method or a Harris Corner Detector method.

FIG. 1C shows an example of the image re-capturing interface 120. In this embodiment, an arrow indication A and a frame F appear on the image re-capturing interface 120 to indicate a direction D for capturing the auxiliary image when the image re-capturing program is executed.

More specifically, the direction D is to indicate to the user to posit the image sensor 15 to face a specific view which the image sensor 15 faces when capturing the second sub image. In other words, when the image re-capturing program is executed, the user can move or turn the handheld electronic device 1 (the image sensor 15) to face to the specific view and to go back to a position which the handheld electronic device 1 has posited when capturing the second sub image through the direction D which is indicated by indication A and frame F.

The user moves or turns the handheld electronic device 1 (the image sensor 15) until a preview image corresponding to the second sub image displaying on the image re-capturing interface 120. The preview image displaying on the image re-capturing interface 120 means that the image sensor 15 faces the specific view and the handheld electronic device 1 is on the position. Then, the image sensor 15 captures the first auxiliary image corresponding to the second sub image by a capturing signal S4 which is generated by the input unit 11 by sensing a second control action S3 of the user. In another example, the image sensor 15 may capture the first auxiliary image automatically based on that the preview image is displayed on the image re-capturing interface 120.

After that the image sensor 15 captures the first auxiliary image, the processor 17 replaces the second sub image by the first auxiliary image. Then, the processor 17 returns to the panorama program from the image re-capturing program after the image sensor 15 captures the first auxiliary image to enable the image sensor 15 to capture the third and fourth sub images. As a result, the first sub image, the first auxiliary image (replacing the second sub image), the third sub image and the fourth sub image are stitched together to form the panoramic image.

It shall be noted that in the case that the input unit 11 and the display unit 13 are integrated to the touch display panel, the touch display panel senses the first control action S1 and the second control action S3 to generate the panorama signal S2 and the capturing signal S4 respectively. The touch display panel also displays the panoramic image, the panorama interface 110 and the image re-capturing interface 120.

In other implementations, the handheld electronic device 1 may comprise both the physical button and the touch display panel. One of the physical button and the touch display panel senses one of the first control action S1 and the second control action S3. The other one of the physical button and the touch display panel senses the other one of the first control action S1 and the second control action S3.

It shall be particularly appreciated that in other implementations, the image re-capturing interface 120 may only show either the arrow indication A and the frame F, or other indications to indicate the direction D.

Furthermore, if a shutter speed of the image sensor 15 that captures the four sub images is faster than the fuzzy determining speed of the processor 17, two or more auxiliary images may be captured to replace the corresponding sub images.

More specific, if the four sub images are captured in sequence, however, if the shutter speed is fast enough, the processor 17 may determine that the second sub image is fuzzy after all of the four sub images are captured.

In such a case, the processor 17 determines that the second sub image and the fourth sub image are fuzzy and the image sensor 15 has not captured any auxiliary image for replacing the second sub image and the fourth sub image yet, the processor 17 will capture a second auxiliary image, which is corresponding to the fourth sub image, for replacing the fourth sub image first, and then capture the first auxiliary image, which is corresponding to the second sub image, for replacing the second sub image.

In other words, if the second sub image and the fourth sub image are captured in an order and determined as fuzzy images, the processor 17 will capture the first auxiliary image and the second auxiliary image in the reverse order. The fourth sub image will be determined if it is fuzzy using a similar procedure as described with the second sub image. In addition, the second auxiliary image is captured with the similar capturing procedure of the first auxiliary image. Thus, the details will not be described herein.

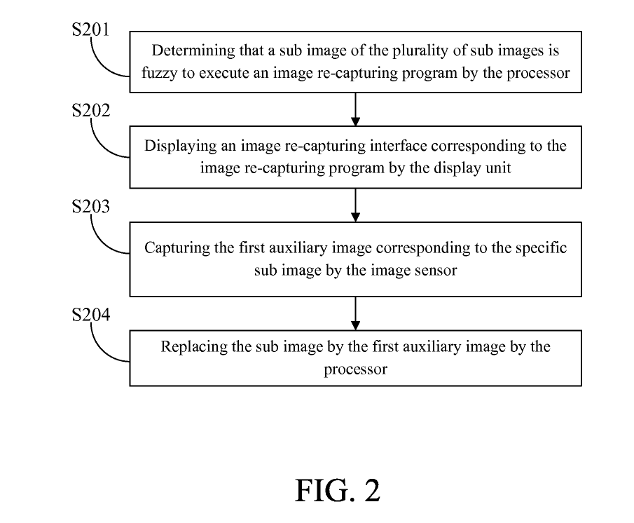

The second embodiment of the present invention is a panoramic image forming method; a flowchart diagram of which is depicted in FIG. 2. The panoramic image forming method is for use in a handheld electronic device (e.g., the handheld electronic device 1 of the first embodiment). The handheld electronic device comprises an input unit, a display unit, an image sensor and a processor. The processor is electrically connected to the input unit, the display unit and the image sensor. The input unit and the display unit, for example, are a physical button and a monitor respectively.

For generating the panoramic image, the input unit senses a first control action from a user to generate a panorama signal. Then, the processor executes a panorama program according to the panorama signal to enable the display unit to display a panorama interface and to enable the image sensor to capture a plurality of sub images to form the panoramic image.

For instance, the panorama interface shows a central point and a horizontal reference line. When the panorama program is executed, the user may use the central point and the horizontal reference line to help the image sensor captures the plurality of sub images. It shall be particularly appreciated that the presentation on the panorama interface of the present invention is not limited thereto.

Moreover, the processor determines whether each of the plurality of sub images is fuzzy just after the corresponding sub image is captured by the image sensor.

Normally, a clear panoramic image will be obtained if each of the plurality of sub images is clear. Nevertheless, if any one of the plurality of sub images is fuzzy, the panoramic image may be fuzzy too. In such a case, the panoramic image forming method is executed by the processor and comprises multiple steps. The steps are detailed as follows.

First, step 201 is executed to determine if a specific sub image of the plurality of sub images is fuzzy to execute an image re-capturing program by the processor. More specifically, the processor determines whether the specific sub image is fuzzy according to hardware information of the handheld electronic device corresponding to the specific sub image or a fuzzy detecting method. The fuzzy detecting method will be described below.

In more details, the hardware information can be any of the following: the shutter period (corresponding to the specific sub image) of the image sensor when capturing the specific sub image, or a motion sensor value of a motion sensor of the handheld electronic device. The motion sensor value is gained by measuring the motion sensor when the image sensor is capturing the specific sub image. The motion sensor value can be, but not limited to, at least one of the following: a sensor shift value while the motion sensor is a gravity sensor of the handheld electronic device, a gyroscope sensor shift value while the motion sensor is a gyroscope sensor of the handheld electronic device, or other sensor values which can represent a motion of the handheld electronic device.

More specifically, the processor can determine that the specific sub image is fuzzy if the shutter period is determined to be lower than a shutter threshold value, if the sensor shift value of the gravity sensor is determined to be higher than a sensor shift threshold value, or if the gyroscope sensor shift value of the gyroscope sensor is determined to be higher than a gyroscope sensor shift threshold value.

It shall be particularly appreciated that the shutter threshold value can be adjusted by the processor according to the environmental background. Normally, the darker the environment background, the higher the shutter threshold value. In other implementations, the shutter threshold can be predetermined and pre-stored in the storage of the handheld electronic device.

As mentioned before, the specific sub image is fuzzy may be determined by the fuzzy determining method. The fuzzy determining method, such as, an edge detecting method, a color distribution detecting method or a high-pass filter detecting method. Furthermore, the high-pass filter detecting method can be a scale-invariant feature transform (SIFT) method, a speeded up robust features (SURF) method, an oriented-BRIEF (ORB) method or a Harris Corner Detector method.

Next, step 202 is executed to display an image re-capturing interface corresponding to the image re-capturing program by the display unit. Then, step 203 is executed to capture the first auxiliary image corresponding to the specific sub image by the image sensor.

In this embodiment, an arrow indication and a frame appear on the image re-capturing interface to indicate a direction for capturing a first auxiliary image when the image re-capturing program is executed.

More specifically, the direction is to indicate to the user to posit the image sensor to face a specific view which the image sensor faces when capturing the specific sub image. In other words, when the image re-capturing program is executed, the user can move or turn the handheld electronic device (the image sensor) to face to the specific view and to go back to a position which the handheld electronic device has posited when capturing the specific sub image through the direction which the arrow indication and the frame indicate to.

The user moves or turns the handheld electronic device (the image sensor) until a preview image corresponding to the specific sub image displaying on the image re-capturing interface. The preview image displaying on the image re-capturing interface means that the image sensor faces the specific view and the handheld electronic device is on the position. Then, the image sensor captures the first auxiliary image corresponding to the specific sub image by a capturing signal which is generated by the input unit by sensing a second control action of the user. Otherwise, the image sensor may capture the first auxiliary image automatically based on that the preview image is displayed on the image re-capturing interface.

Afterwards, step 204 is executed to replace the specific sub image by the first auxiliary image by the processor. After the image sensor captures the first auxiliary image, the processor returns to the panorama program from the image re-capturing program to enable the image sensor to capture the following (next) sub image(s) of the plurality of sub images. The auxiliary image and the plurality of sub images except the specific sub image are stitched together to form the panoramic image.

It shall be noted that in the case that the input unit and the display unit are integrated to the touch display panel, the touch display panel senses the first control action and the second control action to generate the panorama signal and the capturing signal respectively. The touch display panel also displays the panoramic image, the panorama interface and the image re-capturing interface.

In other implementations, the handheld electronic device may comprise both the physical button and the touch display panel. In such a case, one of the physical button and the touch display panel senses one of the first control action and the second control action. The other one of the physical button and the touch display panel senses the other one of the first control action and the second control action.

It shall be particularly appreciated that in other implementations, the image re-capturing interface may only show either of the arrow indication and the frame, or other indications to indicate the direction.

Furthermore, if a shutter speed of the image sensor to capture the plurality of sub images is faster than the fuzzy determining speed of the processor, two or more auxiliary images may need to be captured to replace the corresponding sub images.

More specific, if the specific sub image and the other specific sub image are captured in sequence, however, if the shutter speed is fast enough, the processor may determine that the specific sub image is fuzzy after both of the specific and the other sub images are captured.

In such a case, the processor determines that the specific sub image and an other specific sub image of the plurality of sub images are fuzzy and the image sensor has not captured any auxiliary image for replacing the specific sub image and the other specific sub image yet, the processor will capture a second auxiliary image for replacing the specific sub image first, and then capture the first auxiliary image for replacing the other specific sub image.

In other words, if the specific sub image and the other specific sub image are captured in an order, the processor will capture the first auxiliary image and the second auxiliary image in the reverse order. The specific sub image is subjected to the same fuzzy determining procedure. In addition, the second auxiliary is captured with the similar capturing procedure of the first auxiliary image. Thus, the details would not be described herein.

In addition to the aforesaid steps, the panoramic image forming method of the second embodiment can also execute all the operations and functions of the handheld electronic device set forth in the first embodiment. The method in which the panoramic image forming method of the second embodiment executes these operations and functions can be readily appreciated by those of ordinary skill in the art based on the explanation of the first embodiment, and thus, will not be further described herein.

It should be noted that the panoramic image forming method of the second embodiment may be implemented by a computer program with a plurality of codes. The computer program is stored in a non-transitory machine readable storage medium. When the computer program is loaded and the codes are executed by the processor, the panoramic image forming method of the second embodiment can be accomplished. The non-transitory machine readable storage medium may be a read only memory (ROM), a flash memory, a floppy disk, a hard disk, a compact disk (CD), a mobile disk, a magnetic tape, a database accessible to networks, or any other storage media with the same function and well known to those skilled in the art.

As can be known from the description of the aforesaid embodiments, the present invention allows the user to form a panoramic image in a convenient way through the use of the image re-capturing interface provided by the image re-capturing program. With the present invention, the user can obtain panoramic images more conveniently.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A handheld electronic device for generating a panoramic image formed by a plurality of sub images, comprising:
an input unit, being configured to sense a control action to generate a panorama signal;
a display unit;
an image sensor, being configured to capture a specific sub image of the plurality of sub images according to the panorama signal; and
a processor electrically connected with the input unit, the display unit and the image sensor, being configured to determine that the specific sub image is fuzzy so that the processor executes an image re-capturing program to:
enable the display unit to display an image re-capturing interface;
enable the image sensor to capture a first auxiliary image corresponding to the specific sub image; and
replace the specific sub image by the first auxiliary image.

2. The handheld electronic device as claimed in claim 1, wherein the processor determines that the specific sub image is fuzzy according to hardware information of the handheld electronic device corresponding to the specific sub image;
wherein the hardware information is at least one of a shutter period corresponding to the specific sub image and a motion sensor value of a motion sensor of the handheld electronic device.

3. The handheld electronic device as claimed in claim 1, wherein the processor determines that the specific sub image is fuzzy according to at least one of an edge detecting method, a color distribution detecting method and a high-pass filter detecting method.

4. The handheld electronic device as claimed in claim 1, wherein the image re-capturing interface shows at least one of an arrow indication and a frame to indicate a direction for capturing the first auxiliary image.

5. The handheld electronic device as claimed in claim 4, wherein the first auxiliary image is automatically captured based on the at least one of the arrow indication and the frame.

6. The handheld electronic device as claimed in claim 1, wherein, the processor further determines that an other specific sub image of the plurality of sub images is fuzzy so that the processor enables the image sensor to capture a second auxiliary image corresponding to the other specific sub image by executing the image re-capturing program to replace the other specific sub image by the second auxiliary image;
wherein the other specific sub image is captured later than the specific sub image, and the second auxiliary image is captured earlier than the first auxiliary image.

7. A panoramic image forming method for use in a handheld electronic device, the handheld electronic device comprising an input unit, a display unit, an image sensor and a processor electrically connected to the input unit, the display unit and the image sensor, the input unit being configured to sense a control action to generate a panorama signal, the image sensor being configured to capture a plurality of sub images for forming a panoramic image according to the panorama signal, and the panoramic image forming method comprising the following steps of:
determining that a specific sub image of the plurality of sub images is fuzzy to executes an image re-capturing program by the processor;
displaying an image re-capturing interface corresponding to the image re-capturing program by the display unit;
capturing a first auxiliary image corresponding to the specific sub image by the image sensor; and
replacing the specific sub image by the first auxiliary image by the processor.

8. The panoramic image forming method as claimed in claim 7, wherein the step of determining a specific sub image of the plurality of sub images is fuzzy further comprises:
determining that the specific sub image is fuzzy according to hardware information of the handheld electronic device corresponding to the specific sub image by the processor;
wherein the hardware information is one of a shutter period and a motion sensor value of a motion sensor of the handheld electronic device.

9. The panoramic image forming method as claimed in claim 7, wherein the step of determining that the specific sub image of the plurality of sub images is fuzzy further comprises:
determining that the specific sub image is fuzzy according to at least one of an edge detecting method, a color distribution detecting method and a high-pass filter detecting method by the processor.

10. The panoramic image forming method as claimed in claim 7, wherein the image re-capturing interface shows at least one of an arrow indication and a frame to indicate a direction for capturing the first auxiliary image.

11. The panoramic image forming method as claimed in claim 10, wherein the first auxiliary image is automatically captured based on the at least one of the arrow indication and the frame.

12. The panoramic image forming method as claimed in claim 7, further comprising the following steps of:
determining an other specific sub image of the plurality of the specific sub images is fuzzy by the processor, wherein the other specific sub image of the plurality of sub images is captured later than the specific sub image;
capturing a second auxiliary image corresponding to the other specific sub image by the image sensor before the step of capturing the first auxiliary image corresponding to the specific sub image by the image sensor; and
replacing the other specific sub image by the second auxiliary image by the processor.

13. A non-transitory machine readable medium storing a program for a handheld electronic device to perform a panoramic image forming method, the handheld electronic device comprising an input unit, a display unit, an image sensor and a processor, the input unit being configured to sense a control action to generate a panorama signal, the image sensor being configured to capture a plurality of sub images for forming a panoramic image according to the panorama signal, the program comprising:
a code for the processor to determine that a specific sub image is fuzzy to executes an image re-capturing program;
a code for the display unit to display an image re-capturing interface corresponding to the image re-capturing program;
a code for the image sensor to capture a first auxiliary image corresponding to the specific sub image; and
a code for the processor to replace the specific sub image by the first auxiliary image.

14. The non-transitory machine readable medium as claimed in claim 13, wherein the code for the processor to determine that the specific sub image is fuzzy further comprises a code for the processor to determine that the specific sub image is fuzzy according to hardware information of the handheld electronic device corresponding to the specific sub image;
wherein the hardware information is one of a shutter period corresponding to the specific sub image and a motion sensor value of a motion sensor of the handheld electronic device.

15. The non-transitory machine readable medium as claimed in claim 13, wherein the code for the processor to determine that the specific sub image is fuzzy further comprises a code for the processor to determine that the specific sub image is fuzzy according to at least one of an edge detecting method, a color distribution detecting method and a high-pass filter detecting method.

16. The non-transitory machine readable medium as claimed in claim 13, wherein the image re-capturing interface shows at least one of an arrow indication and a frame to indicate a direction for capturing the first auxiliary image.

17. The non-transitory machine readable medium as claimed in claim 16, wherein the first auxiliary image is automatically captured based on the at least one of the arrow indication and the frame.

18. The non-transitory machine readable medium as claimed in claim 13, further comprises:
a code for the processor to determine that an other specific sub image of the plurality of sub images is fuzzy, wherein the other specific sub image is captured later than the specific sub image;
a code for the image sensor to capture a second auxiliary image corresponding to the other specific sub image before the code for the image sensor to capture the first auxiliary image corresponding to the specific sub image; and
a code for the processor to replace the other specific sub image by the second auxiliary image.
